(19) United States
(12) Patent Application Publication
(10) Pub. No.: US 2007/0178024 A1
(43) Pub. Date: Aug. 2, 2007

(54) Exhaust Line And Power Train Comprising Same

(75) Inventor: Christian Sarda, Montenois (FR)

Correspondence Address: YOUNG & THOMPSON, 745 SOUTH 23RD STREET, 2ND FLOOR, ARLINGTON, VA, 22202, US

(73) Assignee: FAURECIA SYSTEMES D'ECHAPPEMENT, Nanterre (FR)

(21) Appl. No.: 10/573,404

(22) PCT Filed: Sep. 23, 2004
(86) PCT No.: PCT/FR04/02400

§ 371 Date: Nov. 20, 2006

(30) Foreign Application Priority Data
Sep. 26, 2003 (FR) 0311327

(51) Int. Cl. B01D 50/00

(52) U.S. Cl. 422/171

(57) ABSTRACT

An exhaust pipe includes a thin metal tube having a wall thickness of less than 1 mm and, over at least a portion of its length, a peripheral sheath formed from a thermally expandable material.

### FIELD OF THE INVENTION

The present invention relates to an exhaust pipe and also to a motive power unit comprising a heat engine at the outlet of which a depollution device is provided, such an exhaust pipe being provided between the heat engine and the catalytic purification device.

### BACKGROUND OF THE INVENTION

In order to satisfy the requirements laid down for the preservation of the environment, motor vehicles powered by a heat engine are commonly equipped with a catalytic depollution device on the exhaust line. The active elements used in the catalytic depollution device operate satisfactorily only at a temperature much higher than the atmospheric temperature. This operating temperature is from 300° C. to 1000° C.

The catalytic depollution device is brought up to temperature and maintained at temperature by the circulation of the hot exhaust gases coming from the engine.

When the engine is started, after the vehicle has been immobilized for a long period, the depollution device is not immediately efficient, and its temperature increases regularly as the exhaust gases circulate.

In order to enable the depollution device to reach its normal operating temperature as quickly as possible, it is located as close to the engine as possible. Thus, the engine and the depollution device are often separated only by the exhaust manifold, the depollution device being located immediately at the outlet of that manifold.

However, even though the depollution device is located near the engine, the depollution device reaches its normal operating temperature only after a relatively long period of time, in the course of which the exhaust gases are not correctly treated by the depollution device.

### SUMMARY OF THE INVENTION

The object of the invention is to propose a solution for reducing the time during which the depollution device is inefficient.

To that end, the invention relates to an exhaust pipe comprising a thin metal tube having a wall thickness of less than 1 mm, which tube comprises, over at least a portion of its length, a peripheral sheath formed from a thermally expandable material.

According to particular embodiments, the exhaust pipe comprises one or more of the following features:

the thermally expandable peripheral sheath has a thickness of from 0.5 mm to 20 mm and preferably from 2 mm to 15 mm;

the thermally expandable material is composed of refractory ceramic fibers, of vermiculite and of an organic binder;

at the normal operating temperature of the exhaust pipe, the thermally expandable peripheral sheath has a density substantially equal to 1;

it comprises a thermally insulating layer interposed between the thin tube and the thermally expandable peripheral sheath;

the thermally insulating layer comprises long polycrystalline ceramic fibers;

the thickness of the thermally expandable peripheral sheath is greater than 70% of the cumulative thicknesses of the thermally insulating sheath and the thermally expandable peripheral sheath;

it comprises an external casing for holding the thermally expandable peripheral sheath; and

the thermally expandable peripheral sheath comprises two unconnected sleeves, these two unconnected sleeves being surrounded by the same external peripheral casing extending from the one to the other along the thin tube, a space filled with air thus being delimited, between the two unconnected sleeves of peripheral sheath, by the thin tube and the casing.

The invention relates also to a manifold comprising several convergent exhaust pipes such as defined above.

Finally, the invention relates to a motive power unit comprising a heat engine, an exhaust line comprising at least one catalytic depollution device, characterized in that the portion of the exhaust line between the engine and the catalytic purification device comprises at least one exhaust pipe or a manifold such as are defined above.

### BRIEF DESCRIPTION OF THE DRAWINGS

The invention will be better understood on reading the following description which is given purely by way of example and with reference to the drawings in which:

FIG. 1 is a diagrammatic view of a motive power unit of a motor vehicle;

FIG. 2 is a cross-sectional view of the manifold of the motive power unit in FIG. 1;

FIG. 3 is a longitudinal section through the manifold of FIG. 2;

FIG. 4 is a cross-section through a single exhaust pipe according to the invention;

FIGS. 5 and 6 are views identical to those of FIGS. 2 and 3, respectively, of a variant of a manifold according to the invention; and

FIG. 7 is a view in longitudinal section of an exhaust pipe according to yet another variant of the invention.

### DETAILED DESCRIPTION

FIG. 1 shows a geared motor unit of a motor vehicle. This geared motor unit comprises an engine 12 to the outlet of which an exhaust line 14 is connected.

The engine 12 is a heat engine, such as an internal combustion engine or a diesel engine. In the example considered, the engine is a four-cylinder engine which therefore has four exhaust outlets. The exhaust line 14 is equipped with a first catalytic purification device 12. This catalytic purification device comprises, for example, a porous substrate through which the exhaust gases pass, the substrate being covered with precious metals. The normal operating temperature of the catalytic purification device is from 300° C. to 1000° C.

The exhaust line comprises an exhaust manifold 18 between the four outlets of the engine 12 and the first catalytic purification device 16.

Finally, the exhaust line comprises a pipe 20 for evacuating the exhaust gases, which pipe 20 is connected to the outlet of the catalytic purification device 16. The evacuation pipe 20 opens out to the atmosphere. A second catalytic purification device 22 is located in the linear portion of the evacuation pipe 20. As is known per se, the pipe 20 may also be equipped with other catalytic purification devices and/or with particle filters.

The manifold 18 comprises four separate pipes 18A, 18B, 18C, 18D which are connected to each other by one end where they converge to form a common pipe 24. This common pipe is connected at its free end to the inlet of the catalytic purification device 16. The manifold 18 has a flange for securing to the four exhaust outlets of the engine. This flange is located at the ends of the four pipes of the manifold in order to ensure that they are connected to the corresponding outlets of the engine.

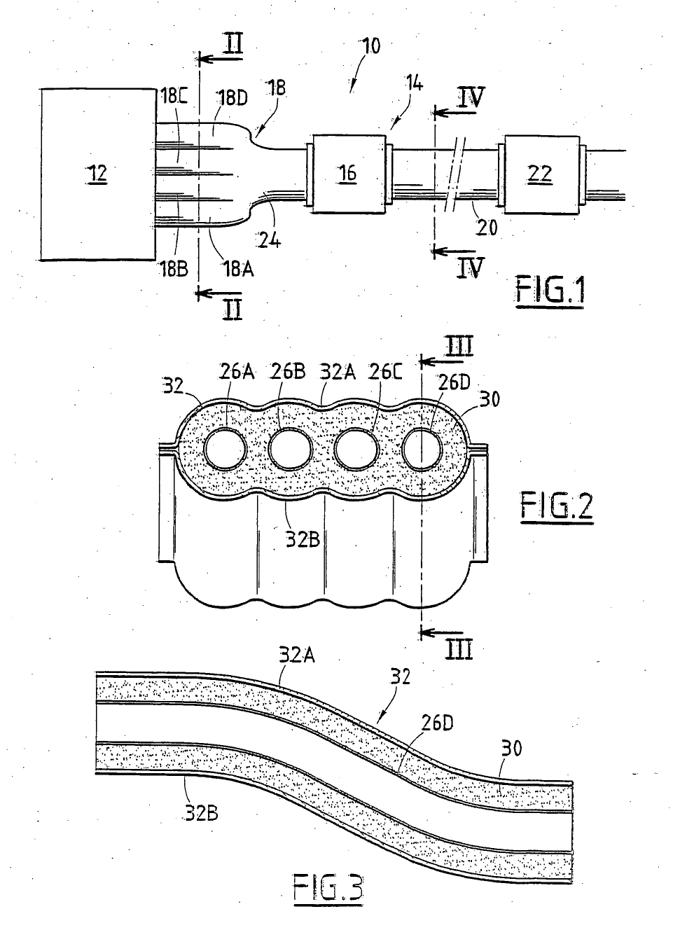

Each exhaust pipe 18A, 18B, 18C, 18D of the manifold comprises, as illustrated in FIGS. 2 and 3, four thin-walled metal tubes 26A, 26B, 26C, 26D. The metal tubes have a wall thickness of less than 1 mm. This thickness is advantageously less than 0.5 mm and is preferably from 0.2 mm to 0.4 mm.

A peripheral sheath 30 formed from a thermally expandable material extends around each tube over at least a portion of the length thereof. Advantageously, the sheath extends over the entire length of the pipes. The thermally expandable sheath is surrounded by an outer casing 32 for holding the sheath 30 around the tubes.

As illustrated in FIG. 2, in the region where the four thin tubes of the four convergent pipes are adjacent to each other, the material forming the thermally expandable sheath 30 is received in a common casing 32 surrounding the four tubes.

Advantageously, this casing 32 is formed by two half-shells 32A, 32B which are connected to each other along two longitudinal joints extending along the length of the pipes. For their connection, the two half-shells comprise an outer longitudinal flange along which these two half-shells are placed side by side.

The thermally expandable material forming the peripheral sheath and surrounding the tubes is sometimes referred to as an “intumescent material”.

A material of that type is such that, when the temperature rises, the volume of the material increases significantly. In the case in point, when the temperature increases, the material is placed against the outer wall of the thin tubes, thus stiffening them.

For example, the thermally expandable material is composed of refractory ceramic fibers, vermiculite, and an organic binder, especially latex, thus ensuring the cohesion of the thermally expandable material. Vermiculite has the property of expanding when the temperature increases.

That type of material can withstand temperatures of up to 850° C. Such materials are marketed in layer form, in particular, by the company 3M under the references INTERAM 100/200/550, and by the company UNIFRAX under the references XPEAV2 and AV2i.

The thickness of the thermally expandable sheath surrounding each thin tube is from 0.5 mm to 20 mm. Preferably, this thickness is from 2 mm to 15 mm.

The amount of thermally expandable material disposed between the thin tubes and the casing is selected in such a manner that the sheath has, in the space thus delimited and at the temperature of use envisaged, an average density of approximately 1. This average density is often referred to by the acronym “GBD”, which stands for Gap Bulk Density.

According to the first embodiment of the invention and as illustrated in FIG. 4, the pipe 20, at least upstream of the second catalyst 22, is formed by a thin tube 34 which has a thickness of less than 0.5 mm and which is surrounded by a thermally expandable peripheral sheath 36 such as described above. A casing marked 38 and formed by a tube surrounds the sheath 36.

By way of variation, the evacuation pipe 20 is formed by a metal tube which has a thickness greater than 5 mm and which is not covered by a thermally expandable sheath, only the manifold 18 located between the engine 12 and the catalytic purification device having the structure described above.

In order to manufacture such an exhaust pipe, and in accordance with a first method, the thin tube is introduced into the external casing. They then together delimit an annular gap into which the thermally expandable material is injected by spraying using a device such as that described in the document EP 0 091 413.

By way of variation, the thermally expandable material is in the form of a layer which is wrapped or non-wrapped. The layer is wound around the thin tube. The whole formed by the thin tube and the layer is introduced into the casing and is secured there by any appropriate means.

When an engine is started cold, the exhaust gases circulating in the exhaust line transfer heat energy for heating the walls of the exhaust pipes. Inasmuch as the walls of the tubes upstream of at least the first catalytic purification device have a reduced thickness, these walls rise in temperature very quickly, so that little heat energy coming from the exhaust gases is lost for heating the walls. Thus, the heat energy conveyed by the exhaust gases is transported substantially as far as the catalytic purification device and enables the temperature thereof to be increased very rapidly.

In addition, during the heating of the walls, the thermally expandable material increases in volume and compresses the walls of the thin tubes. Therefore, the thin tubes are clamped at their periphery by the thermally expandable material, thus increasing the general rigidity of the manifold, even though the rigidity inherent in each thin tube is low owing to their reduced thickness and their increased deformability caused by the elevated temperature.

Thus, with a manifold according to the invention and, more generally, with an exhaust pipe such as defined above, it is possible to very rapidly transfer heat conveyed by exhaust gases to an item of equipment to be heated, without losing a substantial portion of the heat being conveyed by the exhaust gases to dissipation through the pipes, due to the small thickness of the thin tubes used.

Moreover, the proposed arrangement has a relatively low mass, while at the same time having sufficient rigidity for the applications considered.

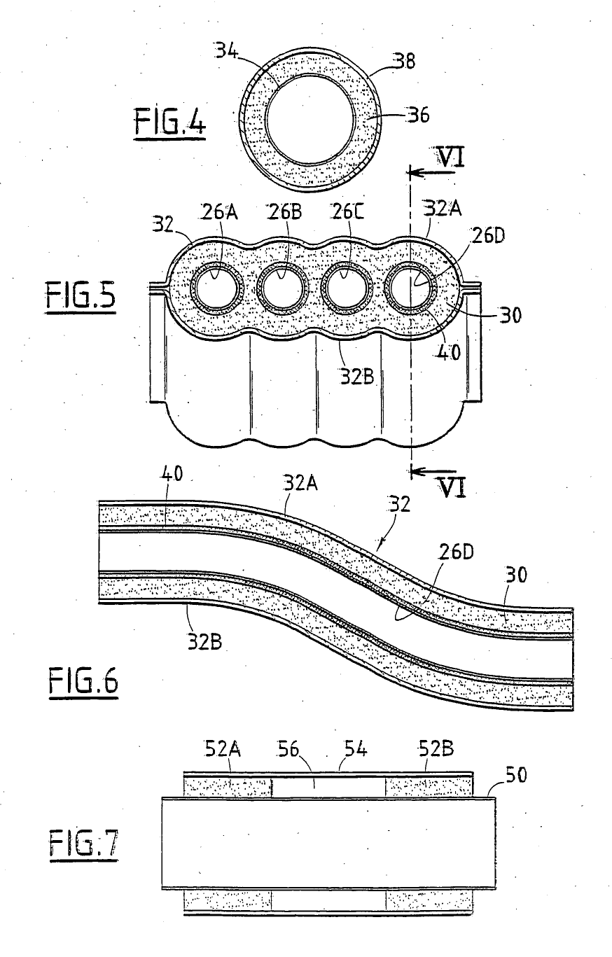

FIGS. 5 and 6 show a variant of a manifold.

In this embodiment, elements that are identical or similar to those of the embodiment of FIGS. 2 and 3 are marked by the same reference numerals.

In this embodiment, a layer 40 of thermal insulation is interposed between the outer surface of the thin-walled tubes and the thermally expandable sheath 30. This sheath completely surrounds the thin tubes over their entire periphery. It is placed directly in contact with the outer surface of these thin tubes.

The thermally insulating layer is formed from long ceramic fibers. It is composed, for example, of polycrystalline fibers formed from mullite or aluminum oxide, these polycrystalline fibers optionally being held in place by a binder. Such a layer is adapted to withstand a temperature of 1200° C. and provides thermal protection for the thermally expandable sheath. Such layers are marketed, for example, by the company SAFFIL under the references LDM and ECOFLEX 200, by the company IBIDEN under the reference FLEC N-2.3 or by the company UNIFRAX under the reference CCmax 4HP. In the example considered, the thickness of the layer 40 is of the order of 2 mm, while the thickness of the thermally expandable sheath 30 is 8 mm. More generally, the thermally expandable layer extends advantageously over more than 70% of the cumulative thickness of the thermally expandable sheath and the thermally insulating layer.

According to a variant illustrated in FIG. 7, the thin tube marked 50 is surrounded by a sleeve 52A, 52B of thermally expandable material only at two unconnected portions of the tube. A casing 54 is arranged around the tube. This casing extends from one sleeve of thermally expandable material to the other. Thus, a free space 56 is delimited between the casing and the thin tube, between the two sleeves of thermally expandable material.

In this arrangement, the free space 56 delimited between the two sleeves 52A, 52B of thermally expandable material forms thermal insulation which prevents the loss of heat energy to the outside.

1-13. (canceled)

14. An exhaust pipe comprising a thin metal tube having a wall thickness of less than 1 mm, which tube comprises, over at least a portion of its length, a peripheral sheath formed from a thermally expandable intumescent material.

15. An exhaust pipe according to claim 14, wherein the thermally expandable peripheral sheath has a thickness of from 0.5 mm to 20 mm, and preferably from 2 mm to 15 mm.

16. An exhaust pipe according to claim 14, wherein the thermally expandable material comprises vermiculite.

17. An exhaust pipe according to claim 16, wherein the thermally expandable material is composed of refractory ceramic fibers, vermiculite, and an organic binder.

18. An exhaust pipe according to claim 14, wherein at the normal operating temperature of the exhaust pipe, the thermally expandable peripheral sheath has a density substantially equal to 1.

19. An exhaust pipe according to claim 14, further comprising a thermally insulating mat interposed between the thin tube and the thermally expandable peripheral sheath.

20. An exhaust pipe according to claim 19, wherein the thermally insulating mat comprises long polycrystalline ceramic fibers.

21. An exhaust pipe according to claim 19, wherein the thickness of the thermally expandable peripheral sheath is greater than 70% of the cumulative thicknesses of the thermally insulating sheath and the thermally expandable peripheral sheath.

22. An exhaust pipe according to claim 14, further comprising an external casing for holding the thermally expandable peripheral sheath.

23. An exhaust pipe according to claim 22, wherein the thermally expandable peripheral sheath comprises two unconnected sleeves, said two unconnected sleeves being surrounded by the same external peripheral casing extending from the one to the other along the thin tube, a space filled with air thus being delimited, between the two unconnected sleeves of peripheral sheath, by the thin tube and the casing.

24. A manifold comprising at least two exhaust pipes according to claim 14, said two exhaust pipes converging to form a single pipe.

25. A power train comprising a heat engine, an exhaust line comprising at least one catalytic depollution device, wherein the portion of the exhaust line between the engine and the catalytic purification device comprises at least one exhaust pipe according to claim 14.

26. A power train comprising a heat engine and an exhaust line comprising at least one catalytic depollution device, wherein the portion of the exhaust line between the engine and the catalytic purification device includes at least one manifold according to claim 24.
